(19) United States
(12) Patent Application Publication
(10) Pub. No.: US 2015/0369439 A1
(43) Pub. Date: Dec. 24, 2015

(54) ROTARY LIGHTING AND/OR SIGNALING MODULE

(71) Applicant: Valeo Vision, Bobigny Cedex (FR)

(72) Inventors: Antoine de Lamberterie, Paris (FR); Ziyed Thabet, Paris (FR); Christophe Dubosc, Villemomble (FR); Benoit Reiss, Magency (FR); Stephan Sommerschuh, Paris (FR); Brahim Elhachir, Paris (FR)

(21) Appl. No.: 14/739,263

(22) Filed: Jun. 15, 2015

(30) Foreign Application Priority Data
Jun. 16, 2014 (FR) 1455507

(51) Int. Cl. F21S 8/10

(52) U.S. Cl. CPC F21S 48/1757; F21S 48/1317; F21S 48/115; F21Y 2101/02

(57) ABSTRACT

A method and lighting and/or controlling the turning on of a fixed luminous source able to emit light rays in an optical system of a lighting and/or signaling module mounted movable in rotation between an active lighting and/or signaling position and a rest position.

The turning on and turning off of the luminous source is undertaken as a function of an item of information in respect of the angular position of the optical system during its displacements between said rest position and said active position.

### CROSS-REFERENCE TO RELATED APPLICATIONS

This application claims priority to the French application 1455507 filed on Jun. 16, 2014, which application is incorporated herein by reference and made a part hereof.

### BACKGROUND OF THE INVENTION

1. Field of the Invention

The invention relates to the field of lighting and/or signaling, especially for automotive vehicles. More particularly, the invention relates to a lighting and/or signaling module for an automotive vehicle, and to a headlamp comprising such a module.

2.Description of the Related Art

Document FR 2 817 212, which is equivalent to U.S. Pat. No. 6,648,494, describes an automotive vehicle headlamp with a directional lighting function better known by the acronym DBL (for Dynamic Bending Light). The headlamp comprises: an optical system the lighting direction of which is modified by rotation; an output shaft coupled to the optical system in order to allow the latter to be driven; a motor; and a rotation transmitting mechanism coupled to the motor in order to transmit the rotation of the motor to the output shaft, in which the motor, the output shaft and the rotation transmitting mechanism are placed in a casing body, and a rotary shaft of the motor is supported by the casing body. A shaft supporting an intermediate pinion placed between the motor and the output shaft is supported directly by the casing body.

Document EP 1 285 812 describes a headlamp comprising a movable assembly equipped with a reflector and a light source, and a stationary assembly at least partially bordering the movable assembly, which may turn, relative to the stationary assembly, about a first vertical axis to provide an adjustment in azimuth and about a horizontal transverse axis to provide an adjustment in elevation. The aim of such an arrangement is to keep operating play between the stationary and the movable parts constant.

Document EP 2 423 047, which is equivalent to U.S. Pat. No. 8,690,401, describes a headlamp for an automotive vehicle designed to combine the night-time lighting function with the daytime signaling function known by the acronym DRL (Daytime Running Light). The night-time lighting function is provided by a stationary lighting module, whereas the DRL lighting is produced by means of an array of light-emitting diodes that may be retracted into a position internal to the headlamp.

What is needed, therefore, is a lighting and/or signaling module and method that overcomes one or more of the problems of the prior art.

### SUMMARY OF THE INVENTION

The objective of the invention is to provide a lighting and/or signaling module and headlamp able to carry out at least two lighting and/or signaling functions and of simple and compact construction.

With this aim, the one embodiment of the invention is a method for controlling the turning on of a fixed luminous source able to emit light rays in an optical system of a lighting and/or signaling module mounted movable in rotation between an active lighting and/or signaling position and a rest position, in which the turning on and turning off of the luminous source is undertaken as a function of an item of information about the angular position of the optical system during its displacements between the rest position and the active position.

According to characteristics of various embodiments of the invention:

subsequent to the receipt of a control instruction for displacing the optical system from the rest position to the active position, the luminous source is kept turned off, before undertaking a step of displacing the optical system, and in which the turning on of the luminous source is undertaken only when the optical system is in the active position; and/or

subsequent to the receipt of a control instruction for displacing the optical system from the active position to the rest position, the turning off of the luminous source is commanded before the optical system is no longer in the active position.

In the method according to the invention, the active position is defined by an angular span extending around the stopping position of the optical system in the active position.

According to characteristics of the method according to the invention, the turning on and the turning off is commanded of a first fixed luminous source able to emit light rays toward a reflecting face of a support mounted movable in rotation about a first axis by way of a first actuator, and in which furthermore the turning on and the turning off is commanded of a second fixed luminous source able to emit light rays in a screen of a chassis which lets through the light rays emitted by the first luminous source after reflection on the reflecting face, the commands for turning on and turning off the first luminous source and the second luminous source being dependent on the angular position of at least the chassis.

The conditions for triggering the turning on and the turning off of the first luminous source and those corresponding to the second luminous source may be different, so that for a given angular position of the chassis, it is possible to turn on one of the two luminous sources without turning on the other.

The invention also relates to a lighting and/or signaling module in particular for an automotive vehicle, comprising means of optical deviation of light rays emitted by a first light source, as well as a chassis comprising at least one screen able to take a position in the path of the light rays deviated by the means of optical deviation. The means of optical deviation and the chassis are mounted movable in rotation while the first light source remains fixed, and control means are able to dispatch control instructions to actuators controlling on the one hand the rotation of the means of optical deviation and of the chassis and on the other the turning on and the turning off of the first light source.

In such a module, it is understood that the means of optical deviation and the first light source cooperate to fulfill a regulatory lighting and/or signaling function.

The chassis can be mounted movable in rotation independently of, or integral with, the rotation of the means of optical deviation. It advantageously comprises two screens, the chassis being mounted movable in rotation so as to pass from a first extreme position in which a first screen of the chassis is disposed facing a second distinct luminous source fixed with respect to the first luminous source, to a second extreme position in which the second screen of the chassis is disposed facing the second luminous source.

Furthermore the invention possesses the following characteristics, considered in isolation or in combination:

at least one of the two screens carries optical means able to deviate the light rays passing through it when it is in the active position upstream of the means of optical deviation;

the optical means carried by a first of the two screens are different from the optical means carried by the second of the two screens;

the luminous sources consist of semiconductor sources, and in particular of light-emitting diodes.

The invention also relates to a lighting and/or signaling headlamp for an automotive vehicle, comprising a casing and at least one lighting and/or signaling module, wherein the lighting and/or signaling module is in accordance with the above description. The headlamp may advantageously comprise three lighting and/or signaling modules.

These and other objects and advantages of the invention will be apparent from the following description, the accompanying drawings and the appended claims.

### BRIEF DESCRIPTION OF THE ACCOMPANYING DRAWINGS

Other features and advantages of the present invention will become more clearly apparent from the description and the drawings, in which:

FIG. 1 is a three-quarter front perspective view of a lighting and/or signaling module according to a first embodiment of the invention, represented here in a first position with a neutral aesthetic face of a support, which face is rotated toward the front of the vehicle, and with a screen of a chassis which is facing this aesthetic face; and

FIG. 2 is a view, similar to that of FIG. 1, of the module represented in a second position with an unchanged support and a chassis rotated by 180° so that the screen is facing a reflector-forming face, opposite from the aesthetic face.

### DETAILED DESCRIPTION OF THE PREFERRED EMBODIMENTS

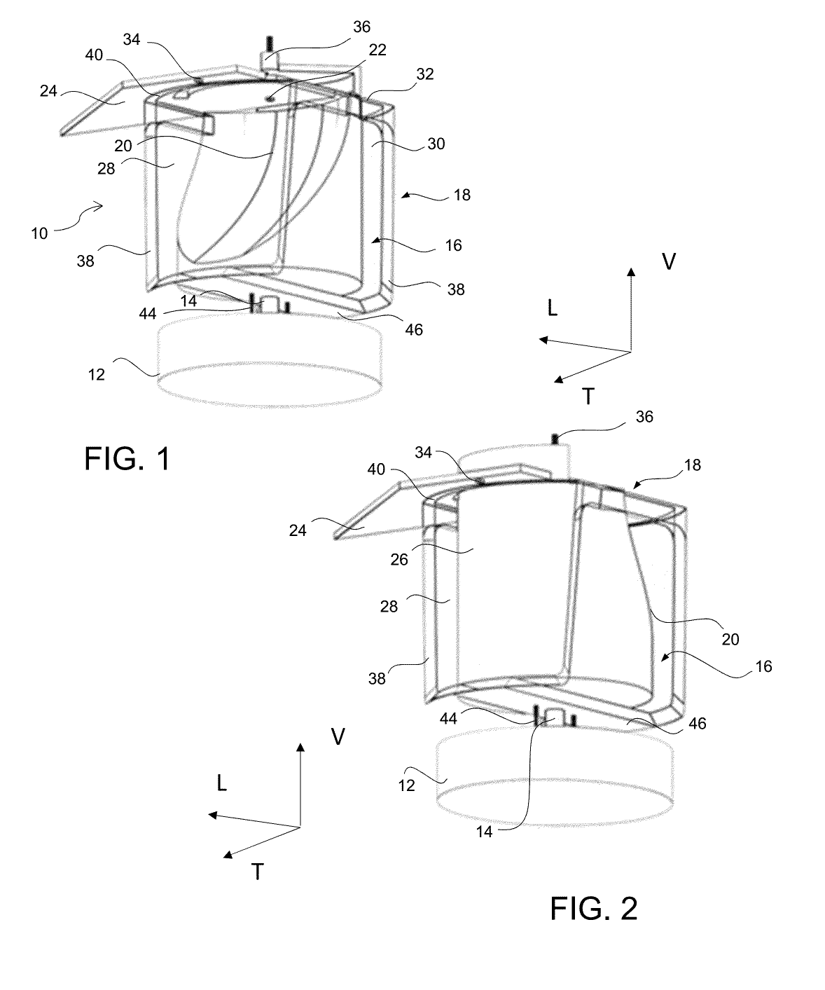

In the following description, nonlimitingly, longitudinal, vertical and transverse orientations will be adopted in accordance with the orientations conventionally used in the automotive industry as indicated by the trihedron L, V, T depicted in FIG. 1.

According to the invention, a lighting and/or signaling module 10 is fixed in a casing (not represented) of a headlamp, and it comprises a first actuator 12 integral with the casing, a first axis 14 driven in rotation by the first actuator 12 and integral with a support 16, as well as a chassis 18 which comprises at least one screen transparent to light and which is mounted around the support 16 such that the at least one screen of the chassis can be disposed facing one of the faces of the support 16. This chassis 18 may be unable to move relative to the module 10, or indeed be mounted so as to be rotatable, the chassis 18 either rotating as one with the support 16 or indeed independently of the support 16, in such a way that the chassis 18 may turn about the support 16 while the latter either remains stationary or also turns.

The first actuator 12 comprises an electric motor, controlled by control means (not shown in FIGS. 1 and 2) able to transmit a control instruction to the motor, and means for transmitting rotation between the motor and the first axis 14. In the embodiments shown, the first axis 14 supports the lower portion of the support 16, and the first axis 14 is substantially vertical though it could have another orientation.

The support 16 of the module 10 comprises a reflective first face 20 playing the role of a reflector able to carry out a regulatory lighting and/or signaling function. This function is provided by interaction of the reflector 20 with a first light source 22. The first light source 22 remains stationary relative to the first actuator 12.

The term “regulatory” is understood to mean that a lighting and/or signaling function complies with the regulations in force. This regulatory lighting and/or signaling function may be a daytime running light (DRL) function or indeed a low-beam function or even a high-beam function. The reflective first face 20 thus ensures that a regulatory lighting and/or signaling beam is formed directed forward from the vehicle.

The first light source 22 is a semiconductor source, preferably a light-emitting diode (LED), and it is substantially aligned with the first axis 14. The expression “substantially aligned” is understood to mean that the distance between the geometric center of the light-emitting diode 22 and the axis of rotation of the support 16 is no greater than the size of the light-emitting diode 22. The latter may be fixed to and positioned on a printed circuit board 24, itself fixed in the casing (not shown) of the headlamp.

The support 16 of the module 10 also comprises a second face 26 opposite the first face forming the reflector 20 and carrying out a second function. This second function may either be a daytime running light function, or a regulatory low-beam and/or high-beam function, or an aesthetic function.

As illustrated, the module 10 may comprise an upper pivot 36 colinear with the first axis 14, by way of the support 16, in order to increase the precision of the relative positioning of the first light source 22 with respect to the reflector 20.

The chassis 18 is made of a material transparent to light and it comprises two screens 28 and 30 which extend substantially vertically in the module 10, parallel to one another. Each screen 28, 30 has a peripheral edge 38 and an upper edge 40. The screens 28, 30 are linked on the one hand at their upper edge 40 by transverse linking walls 32 which join up perpendicularly to the lateral ends of the upper edge 40 of the screens 28, 30 to form an upper base in particular for rigidifying the chassis 18, and on the other hand at their lower end by a structural element of the chassis 18 which forms a lower base 46 substantially parallel to the horizontal walls. The screens 28, 30 preferably take the form of a sheet-like light guide, with a central portion of the sheet which exhibits a bowed profile whose curvature substantially follows the direction of rotation of the chassis 18. The chassis 18 is thus arranged in the module 10 such that it surrounds the support 16, with the first screen 28 or the second screen 30 which is able according to the position of the chassis 18 to take the active position upstream of the support 16, that is to say in the path of the light rays when the means of optical deviation reflect light rays emitted by the first light source 22 toward the output of the module 10.

The central portion of the sheet of each screen 28, 30 may bear decoupling means, especially prisms, for deviating rays reflected by the reflector 20 and having passed through the screen 28, 30. Provision may in particular be made for the optical devices to be distributed non-uniformly over the central portion of the sheet with respect to the direction of rotation of the chassis 18. The benefit of a non-uniform distribution such as this of the optical devices may lie in a progressivity of the optical effect rendered by the passage of the rays through the screen 28, 30, as it rotates toward the active position.

Provision may be made for the two screens 28, 30 to exhibit different optical surfaces, one exhibiting for example a neutral surface, able to not hinder the diffusion of the light rays emitted by the first light source 22 and deviated by the reflector 20, while the other can comprise optical devices such as have just been described with a non-uniform distribution, or else optical devices whose arrangement can form one or more patterns representative for example of a brand that one wishes to highlight during a signaling function. Other structural differences may appear, such as for example the fact that one of the screens 28, 30 of the chassis 18 carries light-decoupling elements, possibly arranged to form patterns for example on all or part of its surface for the aesthetic function, while the other screen does not exhibit such an aesthetic, remaining neutral.

As was described previously, provision may be made, in a particularly beneficial embodiment rich in possible combinations of lighting and/or signaling functions, in particular in the case where the screens 28, 30 carry their own optical devices, for this chassis 18 to be mounted movable in rotation in a manner independent of the support 16, in such a way that the chassis 18 can rotate about the support 16, while the latter remains fixed or rotates too. For this purpose, the module 10 comprises a second actuator 42 integral with the casing, commanded like the first actuator 12 by control means not represented here, and a second axis 44 driven in rotation by the second actuator 42. The second axis 44 extends parallel to the first axis of rotation 14 of the support, between the second actuator 42 and the structural element 46 of the chassis 18 which extends transversely, perpendicularly to the second axis 44.

The second actuator 42 comprises, equivalently to the first actuator 12, an electric motor and means for transmitting rotation between the motor and the second axis 44. One possible arrangement of the two actuators 12, 42 and of the two axes 14, 44 is illustrated in the figures, it being understood that other types of arrangement may possibly be chosen by those skilled in the art. In the embodiments represented, the structural element of the chassis 18 prolongs substantially perpendicularly the lower end 46 of the at least one screen 28, 30, by extending across the first axis of rotation 14 of the support 16. The structural element of the chassis 18 comprises a through-bore, not visible in the figures, able to allow the first axis of rotation 14 to pass through.

The second axis 44 consists here of two rods which are each linked to the structural element 46 of the chassis 18 and to the second actuator 42, and which are disposed diametrically on either side of the shaft forming the first axis 14.

The second actuator 42 is commanded as a function of a control instruction received from means of control of the module 10, so as to cause the chassis 18 to pivot about the second axis 44 and so as thereby to displace the screen 28, 30 between a retracted position, in which the screen 28, 30 is hardly if at all visible, and an active position, in which the screen 28, 30 is upstream of the support 16. By “upstream” is meant the position in which the screen is disposed between the support 16 and the front of the vehicle, toward which the lighting and/or signaling functions are directed.

In the module 10 according to the invention, provision may be made for a second light source 34, fixed and positioned on a printed circuit board 24, advantageously the board that moreover carries the first light source 22, able to illuminate the screen 28, 30 of the chassis 18 which is in the active position upstream of the support 16. Provision is made for the second light source 34 to be placed at a set distance from the first light source 22 so that the screen 28, 30 of the chassis 18, when it is in the active position upstream of the support 16, is placed plumb with the second light source 34 and can be illuminated by the latter. The second light source 34 is held stationary relative to the first light source 22 and remains stationary when the support 16 and/or chassis 18 turn. It may consist of one or more light-emitting diodes (LEDs).

Therefore, the first screen 28 or the second screen 30 of the chassis 18 when located in this active position upstream of the support 16 is placed plumb with the second light source 34 so as thus to be able to provide a regulatory signaling function when the second light source 34 is turned on. The input face of the chassis 18 for the light rays emitted by this second light source 34 is formed by the upper edge 40 of the screen 28, 30 while the output faces are made in the peripheral edge. Thus, a lighting and/or signaling function is obtained that is different from that obtained by reflection of the light rays of the first light source 22. The peripheral portion of the screen 28, 30 may comprise a prism oriented in such or such a way to ensure light is reflected from the second light source 34 toward the front of the vehicle in order to provide a signaling function and/or toward the back in order to participate in the aesthetic function.

The second light source 34 may be turned on in addition to the first light source 22 in order to make the peripheral portion 38 of the first screen 28, facing the reflector 20, emit light. This allows a first screen 28 of the chassis 18 to be used to complement the reflector 20. One preferred way of using the two light sources 22, 34 is to keep the second light source 34 constantly turned on and to increase the intensity of the second light source 34 if it is desired to implement a signaling function, or indeed to turn on the first light source 22 if it is desired to implement a lighting function.

In variant embodiments (not represented), provision could be made for the chassis 18 to exhibit just a single screen, able to take a retracted position or an active position upstream of the support 16. Also it will be possible to combine the fact that the chassis 18 exhibits one or two screens 28, 30 with the fact that the support 16 and the chassis 18 is or is not mounted movable in rotation.

It is advantageously possible according to the invention to command the rotation of the chassis 18 independently of that of the support 16. According to the traffic and brightness conditions, and/or the driver's instructions, the control device dispatches an instruction to the second actuator 42 to rotate the chassis 18 or not. Advantageously, when the reflector 20 is turned toward the front of the vehicle, the rotation of the chassis 18 is altered so as to dispose in front of the reflector 20 alternatively a first, neutral, screen or a second screen carrying light-decoupling elements, possibly arranged to form patterns for example. Provision could thus be made to rotate the chassis 18 about the support 16 which remains fixed and to turn on the second light source 34 when it is the screen carrying patterns in its center which is facing this source so as to produce a scenario to greet the driver before he enters the vehicle.

In the case of a chassis 18 with one screen, it is possible to command the presence or otherwise of the screen in the active position, that is to say in front of the support's face that is turned toward the front of the vehicle, while in the case of a chassis 18 with two screens 28, 30, it is thus possible to choose which screen of the chassis 18 is upstream of the reflector 20 or of the aesthetic face of the support 16, according to the lighting and/or signaling function that one wishes to perform.

The method for controlling the turning on and turning off of the luminous source during the rotational displacement of the elements of the module 10 will now be described.

The module 10 is initially in a rest position P1 (the position illustrated in FIG. 2). The module 10 is oriented in such a way that the aesthetic or second face 26 is oriented toward the front of the vehicle, so as to be visible from outside the vehicle. A screen of the chassis 18, here the first screen 28, is disposed facing the aesthetic or second face 26, upstream of the latter. In this position a signaling function is advantageously undertaken, by turning on the second light source 34 above the first screen 28 which plays for the light rays penetrating via its upper edge the role of an optical guide with an output face disposed at the periphery. The aesthetic function of the aesthetic or second face 26 of the support 16 may thus be accompanied by the signaling function provided by the chassis 18. This signaling function can be used before starting the vehicle, essentially for aesthetic reasons, or during daytime running, to carry out or participate in the so-called DRL (Day Running Light) daytime lighting function.

When the control means receive an item of information 11 for triggering night-time lighting, either by the driver, or by visibility sensors for example, the control means generate a control instruction C1 in respect of the first actuator 12 to rotate the associated support, so as to cause the support 16 to pivot by 180° and cause the reflecting face to pass to the active position P2, turned toward the front of the vehicle.

At the same time, the control means prepare a control instruction C2 in respect of the first light source 22 to force it to turn on and allow the emission of light rays onto the reflecting face 20. According to the invention, the control means undertake a test T1 to ascertain whether the support 16 has arrived in an active functional position. As long as the response is negative, that is to say that the angular position of the optical system formed by the support 16 does not lie in the span of values defined by the manufacturer, the turn-on control instruction is not dispatched to the first light source 22 and the latter remains turned off. As soon as the response is positive, that is to say that the angular position of the optical system lies in the span of values defined by the constructor, the control instruction C2 is dispatched and the first light source 22 is turned on and emits light rays directed toward the reflecting face 20 of the support 16. The fact of having waited for the position of the reflector 20 to be correct before instigating the turning on of the first light 22 source makes it possible to avoid a reflection of the random rays, which is due to the rotation of the reflector 20 penetrating into the field of the emitted rays.

By way of example, provision is made for an angular span of +/−2° around the stopping position of the reflector 20 in the active position, in which the manufacturer considers that the rotation of the reflector 20 does not disturb the path of the reflected rays as output from the module 10, or at the very least that the disturbances which stem therefrom are acceptable so as to comply with the regulatory conditions of the lighting and/or signaling function performed.

It is understood that, when the lighting and/or signaling function ensured by the reflector 20 is not used, the module 10 adopts, automatically or on the basis of a control item of information 12 received by the control means, a different configuration in which the support 16 of the module 10 is rotated by 180° with respect to the configuration of FIG. 2, so as to resume the rest position P1 and present the second face 26 turned toward the front of the vehicle, so as thus to ensure the aesthetic and/or lighting and/or signaling function also described hereinabove. According to the invention, the first light source 22 should be turned off before the support 16 leaves the active position. In this case, the control means dispatch simultaneously, or quasi-simultaneously, a control instruction C3 to the first actuator 12 to rotate the support 16 and a control instruction C4 to turn off the first light source 22. By quasi-simultaneously is meant a slight temporal offset by which the first light source 22 is turned off after the start of the rotation of the reflector 20 carried by the support 16, while ensuring that the angular position of the optical system lies in the acceptable span of values before the first light source 22 is turned off.

A method has just been described for controlling the turning on of a luminous source in a module 10 in which no chassis is provided movable in rotation about the support 16. An equivalent method will now be described, when provision is made for a chassis 18 comprising at least one screen 28, 30 able to come into place facing the reflector 20 of the support 16, and square with a second light source 34 for a complementary signaling function.

The support 16 is controlled so that the reflector 20 is in the active position P3 (position visible in FIG. 1) as soon as the vehicle is running and the aesthetic function is no longer necessary. The control means give instruction C5 to the second actuator 42 to bring one of the screens 28, 30 into the active position upstream of the reflector 20.

At the same time, the control means prepare an instruction C6 for turning on the second light source 34, so as to allow the emission of light rays in the sheet of the screen disposed under the second light source 34. According to the invention, the control means undertake a test T2 to ascertain whether the optical system formed by the chassis 18 has arrived in an active functional position. As long as the response is negative, that is to say that the angular position of the chassis 18 does not lie in a second span of values defined by the manufacturer, the turn-on control instruction is not dispatched to the first light source 22 and the latter remains turned off. It is understood that the second span of values may be the same as the first span of values, that is to say +/−2° in the numerical example given here by way of nonlimiting example, or else that it may on the contrary be different, and preferably larger than the first span of values. Indeed, the disturbances that the rotation of the chassis 18 may generate on the rays emitted by the second light source 34 may be deemed regulatorily less penalizing, since they impact a signaling function, than the disturbances generated by the rotation of the reflector 20 and of the associated chassis 18 on the rays emitted by the first light source 22 which impact a lighting function. As soon as the response to the test T2 is positive, that is to say that the angular position of the optical system lies in the span of values defined by the manufacturer, the control instruction C6 is dispatched and the second light source 34 is turned on and emits light rays directed toward the first screen 28 arrived under the second light source 34. The fact of having waited for the position of the chassis 18 to be correct before instigating the turning on of the second light source 34 makes it possible to avoid a non-homogeneous internal reflection of the rays on the sheet forming the screen in the active position, and thus to avoid the possibility that only part of the peripheral edge of the screen is illuminated.

The lighting function may also be directional, i.e. of the DBL (Dynamic Bending Light) type, by virtue of the actuator 12 of the module 10, which may rotate the reflector 20 by a few degrees about the first axis 14. This rotation is accompanied by a combined movement of the screen, which remains facing the reflector 20 when the chassis 18 rotates as one with the reflector 20, and, when the chassis 18 is mounted so as to be rotatable independently of the rotation of the reflector 20, the screen is rotated so that the screen nevertheless remains on the axis of emission of the rays reflected by the reflector 20, so that no dispersion of the rays results from this directional lighting. It is understood that, in this case, the first light source 22 remains turned on even if the angle of rotation of the reflector 20 is greater than the threshold defined by the angular span described hereinabove, since the screen follows the rotation of the support.

It should be noted that the beams generated by the one or more modules that were described above may form beams that are complementary to the regulatory beams generated by conventional devices, or indeed that they may all form regulatory lighting and/or signaling beams.

The foregoing description clearly explains how the invention makes it possible to achieve the set objectives and in particular to propose a lighting and/or signaling module 10 in which a chassis 18 complements a rotary support 16 of a reflector 20 able to deviate the light rays emitted by a light source 22, 34, so as to afford complementarity to the signaling function in particular, and to propose a method for controlling the turning on of an associated light source so as to avoid the diffusion of unchecked light rays which may hinder the users of the road upstream of the vehicle. The characteristic according to which the light source 22, 34 is turned off prior to the rotational displacement of the optical system formed by the support 16 and/or the chassis 18, before being turned back on only under conditions of angular position of the optical system, makes it possible to benefit from the multiple possible combinations in the vehicle lighting and/or signaling functions offered by the possible rotations of the reflector 20, support 16 and of the chassis 18 without, however, exhibiting the risk of non-regulatory lighting or signaling.

It will be understood that, in order to provide lighting and/or signaling functions, the headlamp of an automotive vehicle may comprise one or more modules identical to that described above, placed in series in a casing. In the case of a series of several modules, advantageously three, provision could be made to render the support of each module and the chassis of each module rotary via actuators that may be commanded independently of one another, so as to ensure greater flexibility in the lighting and/or signaling functions, and each of the modules will be associated with a control device able to carry out the instructions for implementing the method of controlling turning on according to the invention, it being possible for this control device to be common to the three modules.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A method for controlling the turning on of a luminous source able to emit light rays in an optical system of a lighting and/or signaling module mounted movable in rotation between an active lighting and/or signaling position and a rest position, in which the turning on and turning off of said luminous source is undertaken as a function of an item of information about the angular position of said optical system during its displacements between said rest position and said active position.

2. The method according to claim 1, in which, subsequent to the receipt of a control instruction for displacing said optical system from said rest position to said active position, said luminous source is kept turned off, before undertaking a step of displacing said optical system, and in which the turning on of said luminous source is undertaken only when said optical system is in said active position.

3. The method according to claim 1, in which, subsequent to the receipt of a control instruction (C1, C3) for displacing said optical system from said active position to said rest position, the turning off of said luminous source is commanded before said optical system is no longer in said active position.

4. The method according to claim 1, wherein said active position is defined by an angular span extending around the stopping position of said optical system in said active position.

5. The Method according to claim 1, in which the turning on and the turning off is commanded of a first fixed luminous source able to emit light rays toward a reflecting face of a support mounted movable in rotation about a first axis by way of a first actuator, and in which furthermore said turning on and said turning off is commanded of a second fixed luminous source able to emit light rays in a screen of a chassis which lets through said light rays emitted by said first fixed luminous source after reflection on said reflecting face, said commands for turning on and turning off said first fixed luminous source and said second fixed luminous source being dependent on the angular position of at least said chassis.

6. The method according to claim 5, in which the conditions for triggering said turning on and said turning off of said first fixed luminous source and those corresponding to said second fixed luminous source are different, so that for a given angular position of said chassis, it is possible to turn on one of said two fixed luminous sources without turning on the other.

7. A lighting and/or signaling module in particular for an automotive vehicle, comprising means of optical deviation of light rays emitted by a first light source, as well as a chassis comprising at least one screen able to take a position in the path of said light rays deviated by said means of optical deviation, wherein said means of optical deviation and said chassis are mounted movable in rotation while said first light source remains fixed, and in that control means are able to dispatch control instructions to actuators controlling on the one hand the rotation of said means of optical deviation and of said chassis and on the other hand the turning on and the turning off of said first light source.

8. The lighting and/or signaling module according to claim 7, wherein said chassis is mounted movable in rotation independently of the rotation of said means of optical deviation.

9. The lighting and/or signaling module according to claim 7, wherein said chassis is mounted movable in rotation integral with said rotation of said means of optical deviation.

10. The lighting and/or signaling module according to claim 7, wherein said chassis comprises two screens, said chassis being mounted movable in rotation so as to pass from a first extreme position in which a first screen of said chassis is disposed facing a second distinct luminous source fixed with respect to said first light source, to a second extreme position in which a second screen of said chassis is disposed facing said second distinct luminous source.

11. The lighting and/or signaling module according to claim 7, wherein at least one of said two screens carries optical means able to deviate said light rays passing through it when it is in the active position upstream of said means of optical deviation.

12. The lighting and/or signaling module according to claim 11, wherein said optical means carried by said first of said two screens are different from said optical means carried by said second of said two screens.

13. The lighting and/or signaling module according to claim 7, wherein said first light source and said second distinct luminous source consist of semiconductor sources.

14. A lighting and/or signaling headlamp for an automotive vehicle, comprising a casing and at least one lighting and/or signaling module, wherein said lighting and/or signaling module comprises means of optical deviation of light rays emitted by a first light source, as well as a chassis comprising at least one screen able to take a position in the path of said light rays deviated by said means of optical deviation, wherein said means of optical deviation and said chassis are mounted movable in rotation while said first light source remains fixed, and in that control means are able to dispatch control instructions to actuators controlling on the one hand the rotation of said means of optical deviation and of said chassis and on the other hand the turning on and the turning off of said first light source.

15. The lighting and/or signaling headlamp according to claim 14, wherein it comprises at least two lighting and/or signaling modules.

16. The method according to claim 1, wherein said luminous sources consist of semiconductor sources.

17. A lighting and/or signaling module in particular for an automotive vehicle, comprising an optical deviator of light rays emitted by a first light source, as well as a chassis comprising at least one screen able to take a position in the path of said light rays deviated by said optical deviator, wherein said optical deviator and said chassis are mounted movable in rotation while said first light source remains fixed, and in that a controller is able to dispatch control instructions to actuators controlling on the one hand the rotation of said optical deviator and of said chassis and on the other hand the turning on and the turning off of said first light source.
